(19) United States
(12) Patent Application Publication
(10) Pub. No.: US 2024/0387931 A1
(43) Pub. Date: Nov. 21, 2024

(54) VARIABLE VOLTAGE BATTERY PACK

(71) Applicants: Xiaofei Yang, Guangzhou (CN); Libo Qin, Hubei Province (CN)

(72) Inventor: Libo Qin, Hubei Province (CN)

(21) Appl. No.: 18/789,609

(22) Filed: Jul. 30, 2024

(30) Foreign Application Priority Data
Mar. 6, 2024 (CN) 202420431082.4

(51) Int. Cl. H01M 50/271; H01M 10/613; H01M 10/6562; H01M 50/284

(52) U.S. Cl. CPC H01M 50/271; H01M 10/613; H01M 10/6562; H01M 50/284

(57) ABSTRACT

The present invention discloses a variable voltage battery pack including a bottom cover, a housing, a sampling circuit board, a variable voltage assembly, a spring, a push rod and a ventilation plate; removing the ventilation plate may increase heat dissipation effect inside the housing, and to remove the ventilation plate, a rotating handle is rotated to cause a gear shaft to drive a square column to move so as to remove the square column from an insertion hole in an upper cover, thus removing the ventilation plate and increasing the internal heat dissipation effect, which helps to maintain a normal operating temperature of the battery pack and improve battery performance and life.

### TECHNICAL FIELD

The present invention pertains to the technical field of variable voltage battery packs, and specifically pertains to a variable voltage battery pack.

### BACKGROUND

A variable voltage battery pack is a battery assembly that can adjust voltage output as required, and is generally composed of a plurality of battery cells. The voltage output can be changed by connecting or disconnecting different numbers of battery cells. This design can make the battery pack suitable for different electronic devices or systems and meet different voltage requirements. The variable voltage battery pack is generally used for applications requiring flexible voltage output, such as mobile power banks, solar energy storage systems, etc.

A heat dissipation hole in an upper cover is non-removable, which limits heat dissipation, resulting in rise in internal temperature of the battery pack, so a new apparatus is needed to solve the current problems.

### SUMMARY

It is an object of the present invention to provide a variable voltage battery pack to solve the above-mentioned problems of the prior art in which a heat dissipation hole in an upper cover is non-removable, which limits heat dissipation, resulting in rise in internal temperature of the battery pack, so a new apparatus is needed to solve the current problems.

In order to achieve the above object, the present invention provides the following technical solution: a variable voltage battery pack, includes a bottom cover, where a housing is mounted at an upper end of the bottom cover, a sampling circuit board is mounted at an inner side of the housing, a control board is provided at an upper end of the sampling circuit board, a variable voltage assembly is provided at an upper end of the control board, a spring is provided at a left end of the variable voltage assembly, a push rod is provided at a right end of the variable voltage assembly, a connecting finger male pin is provided at a lower end of the variable voltage assembly located on a left side, a connecting finger female receptacle is provided at the lower end of the variable voltage assembly located on a right side, an upper cover is mounted at an upper end of the housing, a gland is clamped at an upper end of the upper cover, a ventilation plate is mounted at the upper end of the upper cover, the ventilation plate is mounted with the upper cover by clamping plates respectively located at left and right ends, a rotating handle is mounted at an upper end of the ventilation plate, the rotating handle can control a gear column fixed at a lower end to rotate, rotation of the gear column enables a square column sleeved at an inside of the ventilation plate to move, the square column is clamped with the gear column by a gear structure located at a side end surface, and the square column may move into an insertion hole located at an inside of the upper cover.

Preferably, the push rod causes the connecting finger male pin and the connecting finger female receptacle to move when pushed.

Preferably, a female socket is provided at an intermediate position between the connecting finger male pin and the connecting finger female receptacle.

Preferably, the housing wraps the sampling circuit board at an inner side, and the control board is mounted at the upper end of the sampling circuit board.

Preferably, the upper cover discharges heat generated by the variable voltage assembly through the ventilation plate, and the ventilation plate is clamped at the upper end of the upper cover by the clamping plate.

Preferably, a thickness of the clamping plate is less than a thickness of the ventilation plate, and the clamping plate is clamped at an inside of a groove of the upper cover.

Preferably, the rotating handle can control the gear column to rotate, and the square column moves through the gear structure when the gear structure rotates.

Preferably, the square column can move into the inside of the insertion hole.

Compared with the prior art, the present invention provides a variable voltage battery pack, which has the following beneficial effects:

The apparatus is provided with the ventilation plate at the upper end of the upper cover, the ventilation plate is clamped at the inside of the groove of the upper cover by clamping plates; removing the ventilation plate may increase heat dissipation effect inside the housing, and during removal, the rotating handle is rotated to cause the gear shaft to drive the square column to move so as to remove the square column from the insertion hole in the upper cover, thus removing the ventilation plate and increasing the internal heat dissipation effect, which helps to maintain a normal operating temperature of the battery pack and improve battery performance and life.

### BRIEF DESCRIPTION OF THE DRAWINGS

FIG. 1 is a structural schematic diagram of a variable voltage battery pack according to the present invention.

FIG. 2 is a schematic diagram of an internal structure of a variable voltage battery pack according to the present invention.

FIG. 3 is a structural schematic diagram of a variable voltage assembly of a variable voltage battery pack according to the present invention.

FIG. 4 is a schematic diagram of an internal structure of a ventilation plate of a variable voltage battery pack according to the present invention.

Reference numerals in the drawings: 1. gland; 2. push rod; 3. upper cover; 4. housing; 5. bottom cover; 6. spring; 7. variable voltage assembly; 8. control board; 9. sampling circuit board; 10. connecting finger female receptacle; 11. connecting finger male pin; 12. ventilation plate; 13. rotating handle; 14. clamping plate; 15. square column; 16. gear column; 17. insertion hole; 18. gear structure.

### DESCRIPTION OF THE EMBODIMENTS

The technical solutions in the embodiments of the present invention will be described clearly and completely below with reference to the accompanying drawings in the embodiments of the present invention, and it is obvious that the embodiments described are only some, instead of all, of the embodiments of the present invention. All other embodiments obtained by those of ordinary skill in the art based on the embodiments of the present invention without creative work fall within the scope of the present invention.

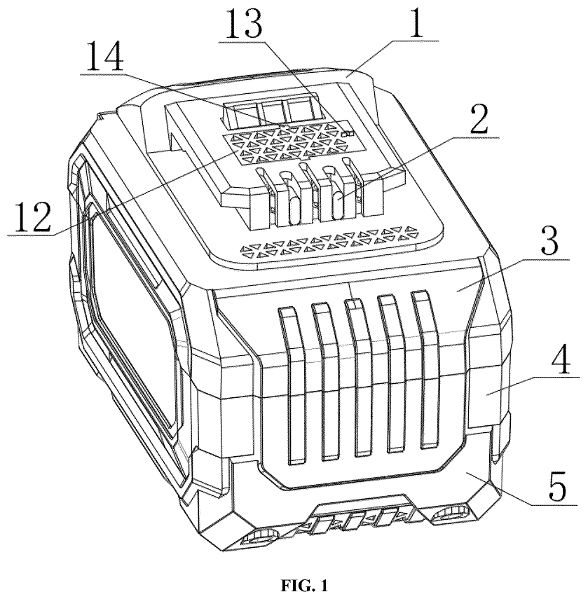

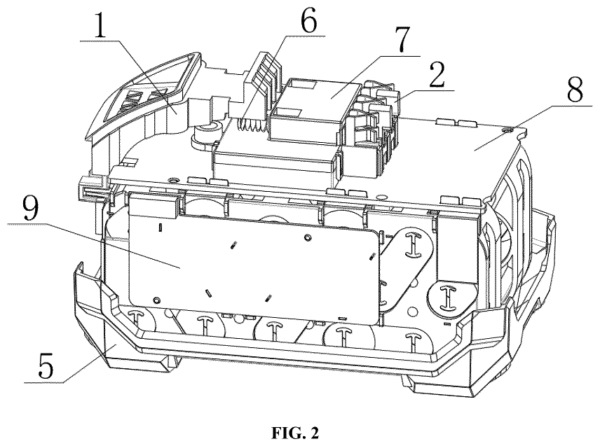

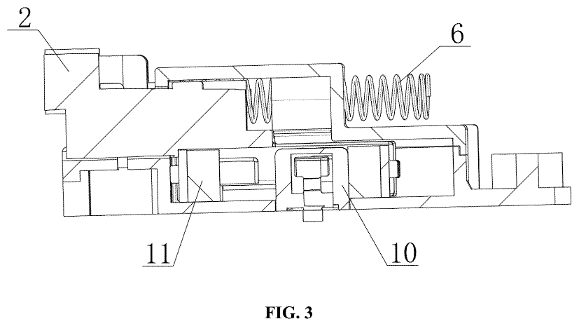

The present invention provides a variable voltage battery pack as shown in FIGS. 1-4, including a bottom cover 5, where a housing 4 is mounted at an upper end of the bottom cover 5, a sampling circuit board 9 is mounted at an inner side of the housing 4, a control board 8 is provided at an upper end of the sampling circuit board 9, a variable voltage assembly 7 is provided at an upper end of the control board 8, a spring 6 is provided at a left end of the variable voltage assembly 7, a push rod 2 is provided at a right end of the variable voltage assembly 7, a connecting finger male pin 11 is provided at a lower end of the variable voltage assembly 7 located on a left side, a connecting finger female receptacle 10 is provided at the lower end of the variable voltage assembly 7 located on a right side, an upper cover 3 is mounted at an upper end of the housing 4, a gland 1 is clamped at an upper end of the upper cover 3, a ventilation plate 12 is mounted at the upper end of the upper cover 3, the ventilation plate 12 is mounted with the upper cover 3 by clamping plates 14 respectively located at left and right ends, a rotating handle 13 is mounted at an upper end of the ventilation plate 12, the rotating handle 13 can control a gear column 16 fixed at a lower end to rotate, rotation of the gear column 16 enables a square column 15 sleeved at an inside of the ventilation plate 12 to move, the square column 15 is clamped with the gear column 16 by a gear structure 18 located at a side end surface, and the square column 15 may move into an insertion hole 17 located at an inside of the upper cover 3.

There are two groups of connecting fingers which are respectively for two different circuits, one group has 12 pings, and 2 pings form one way to increase a current value. By pushing the push rod 2, the two groups of connecting fingers move synchronously, and a female socket is provided at an intermediate position between two connecting fingers. During operation, one group of connecting fingers must be connected to the female socket, and the other group is idle. During conversion, the push rod 2 is pushed to convert the two groups of connecting fingers into each other to achieve the purpose of voltage conversion. One group of connecting fingers has a parallel voltage and has a plurality of cells inside which are connected in parallel to form a plurality of batteries which are then connected in series, and the other group of connecting fingers has a series voltage and has a plurality of cells inside which are connected in parallel to form a plurality of batteries which are then connected in series.

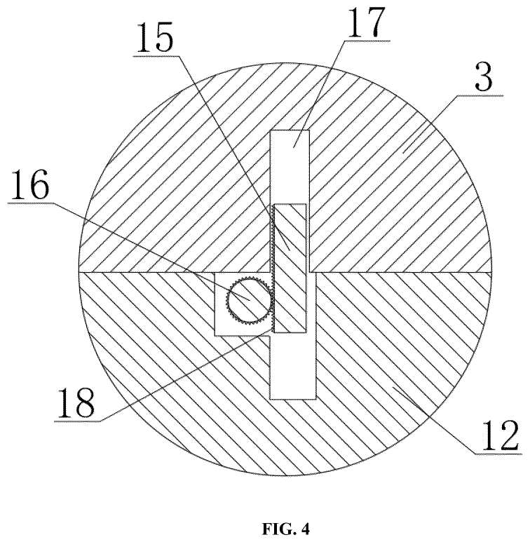

As shown in FIGS. 1 and 4, the push rod 2 causes the connecting finger male pin 11 and the connecting finger female receptacle 10 to move when pushed; a female socket is provided at an intermediate position between the connecting finger male pin 11 and the connecting finger female receptacle 10; the housing 4 wraps the sampling circuit board 9 at an inner side, and the control board 8 is mounted at the upper end of the sampling circuit board 9; the upper cover 3 discharges heat generated by the variable voltage assembly 7 through the ventilation plate 12, and the ventilation plate 12 is clamped at the upper end of the upper cover 3 by the clamping plate 14; a thickness of the clamping plate 14 is less than a thickness of the ventilation plate 12, and the clamping plate 14 is clamped at an inside of a groove of the upper cover 3; the rotating handle 13 can control the gear column 16 to rotate, and the square column 15 moves through the gear structure 18 when the gear structure 18 rotates; and the square column 15 can move into the inside of the insertion hole 17.

The ventilation plate 12 is arranged at the upper end of the upper cover 3, the ventilation plate 12 is clamped at the inside of the groove of the upper cover 3 by the clamping plates 14; removing the ventilation plate 12 may increase heat dissipation effect inside the housing 4, and during removal, the rotating handle 13 is rotated to cause the gear shaft to drive the square column 15 to move so as to remove the square column 15 from the insertion hole 17 in the upper cover 3, thus removing the ventilation plate 12 and increasing the internal heat dissipation effect, which helps to maintain a normal operating temperature of the battery pack and improve battery performance and life.

Finally, it should be noted that the above descriptions are only preferred embodiments of the present invention and are not intended to limit the present invention. Although the present invention has been described in detail with reference to the aforementioned embodiments, those skilled in the art can still modify the technical solutions described in the aforementioned embodiments or equivalently replace some of the technical features. Any modifications, equivalent replacements, improvements, etc. made within the spirit and principles of the present invention shall be included within the protection scope of the present invention.

What is claimed is:

1. A variable voltage battery pack, comprising a bottom cover, wherein a housing is mounted at an upper end of the bottom cover, a sampling circuit board is mounted at an inner side of the housing, a control board is provided at an upper end of the sampling circuit board, a variable voltage assembly is provided at an upper end of the control board, a spring is provided at a left end of the variable voltage assembly, a push rod is provided at a right end of the variable voltage assembly, a connecting finger male pin is provided at a lower end of the variable voltage assembly located on a left side, a connecting finger female receptacle is provided at the lower end of the variable voltage assembly located on a right side, an upper cover is mounted at an upper end of the housing, a gland is clamped at an upper end of the upper cover, a ventilation plate is mounted at the upper end of the upper cover, the ventilation plate is mounted with the upper cover by clamping plates respectively located at left and right ends, a rotating handle is mounted at an upper end of the ventilation plate, the rotating handle can control a gear column fixed at a lower end to rotate, rotation of the gear column enables a square column sleeved at an inside of the ventilation plate to move, the square column is clamped with the gear column by a gear structure located at a side end surface, and the square column may move into an insertion hole located at an inside of the upper cover.

2. The variable voltage battery pack according to claim 1, wherein the push rod causes the connecting finger male pin and the connecting finger female receptacle to move when pushed.

3. The variable voltage battery pack according to claim 2, wherein a female socket is provided at an intermediate position between the connecting finger male pin and the connecting finger female receptacle.

4. The variable voltage battery pack according to claim 1, wherein the housing wraps the sampling circuit board at an inner side, and the control board is mounted at the upper end of the sampling circuit board.

5. The variable voltage battery pack according to claim 1, wherein the upper cover discharges heat generated by the variable voltage assembly through the ventilation plate, and the ventilation plate is clamped at the upper end of the upper cover by the clamping plate.

6. The variable voltage battery pack according to claim 5, wherein a thickness of the clamping plate is less than a thickness of the ventilation plate, and the clamping plate is clamped at an inside of a groove of the upper cover.

7. The variable voltage battery pack according to claim 1, wherein the rotating handle can control the gear column to rotate, and the square column moves through the gear structure when the gear structure rotates.

8. The variable voltage battery pack according to claim 7, wherein the square column can move into the inside of the insertion hole.
